(19) United States
(12) Patent Application Publication
(10) Pub. No.: US 2017/0275913 A1
(43) Pub. Date: Sep. 28, 2017

(54) STRUCTURE OF LOCK

(71) Applicant: Te-Yu Chen, Pingtung City (TW)

(72) Inventor: Te-Yu Chen, Pingtung City (TW)

(21) Appl. No.: 15/076,667

(22) Filed: Mar. 22, 2016

(51) Int. Cl. E05B 13/00; E05B 17/20

(52) U.S. Cl. CPC E05B 13/002; E05B 17/20

(57) ABSTRACT

A structure of lock includes a core shaft, a swing arm, a push bar, and a keeper plate that are arranged in a lock. The swing arm is arranged at one side of the core shaft to selectively push or separate from a bolt. The push bar is arranged on an axle and has a top edge forming a notch. The keeper plate includes an elongate slide hole formed therein and an elongate positioning hole also formed therein and located below the slide hole. The slide hole is slidably fit over the axle and the positioning hole is slidably fit over a bar in such a way that the keeper plate is movable up and down along a curved path.

### TECHNICAL FIELD OF THE INVENTION

The present invention generally relates to an improved structure of lock, and in particular to a lock that makes the thieves mistakenly believe the lock is damaged and thus giving up the attempt for breaking in so as to achieve the purpose of burglary protection and that allows rescuers to unlock the lock from an outdoor side by using a proper key even when an intruder secures the lock from the indoor side.

### DESCRIPTION OF THE PRIOR ART

A conventional lock is often secured by using a key when a user gets outdoors. When a thief attempts to legally intrude the house, the thief may use a lock release tool to rotate and open a lock core and the release the lock by rotating a handle. For some locks having sophisticated designs, it is not possible for the thief to open the lock shortly, and thief often forcibly rotates the handle to make the lock lose the function of locking. It is generally known that the conventional locks are incapable of preventing thefts and may cause concerns about the lock being damaged. Further, in case that an intruder intrudes a house and takes hostage in the house, due to the lock may be secured from the indoor side, the rescuers are prevented from releasing the lock from the outdoor side, making them losing the opportunity of rescue at the first time. It is thus desired to provide a lock that is safer for the general consumers.

### SUMMARY OF THE INVENTION

The primary object of the present invention is to provide an improved structure of lock that makes thieves mistakenly believe the lock is damaged due to incapable of unlocking the lock and thus giving up the attempt for breaking in so as to achieve the purpose of burglary protection and that allows rescuers to unlock the lock from outdoor side by using a proper key even when an intruder secures the lock from the indoor side

The above-discussed structure of lock comprises a core shaft, a swing an a push bar, and a keeper plate that are arranged in a lock. The push bar is arranged on an axle and has a top edge forming a notch. The keeper plate comprises an elongate slide hole Ruined therein and an elongate positioning hole also formed therein and located below the slide hole. The slide hole is slidably fit over the axle and the positioning hole is slidably fit over a bar in such a way that the keeper plate is movable up and down along a curved path. When the lock is in a locked condition, the keeper plate abuts against the core shaft to prevent a handle from being operated from an outdoor side for opening. When a thief attempts to rotate the core shaft, due to being incapable of operating for opening, the thief may mistakenly believe the lock is damaged so that the thief may give up the attempt of intrusion. As such, the purpose of theft protection can be achieved. When an intruder has intruded and secures the lock from the indoor side, a rescuer may use a key to open the core shaft from the outdoor side.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing the structure of the present invention.

FIG. 2 is a schematic view showing a free-to-open condition of the present invention.

FIG. 3 is a schematic view showing a locked condition of the present invention.

FIG. 4 is a schematic view showing an unlocked condition of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

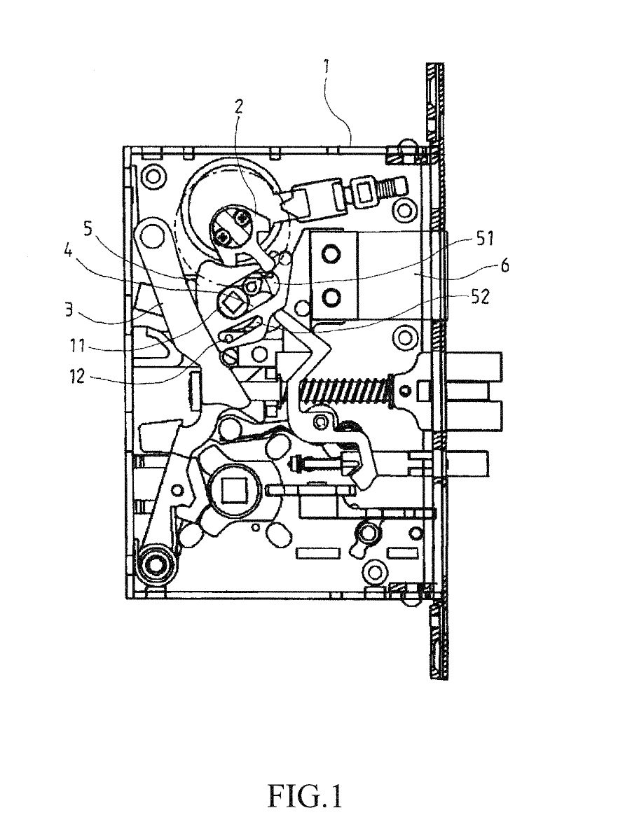

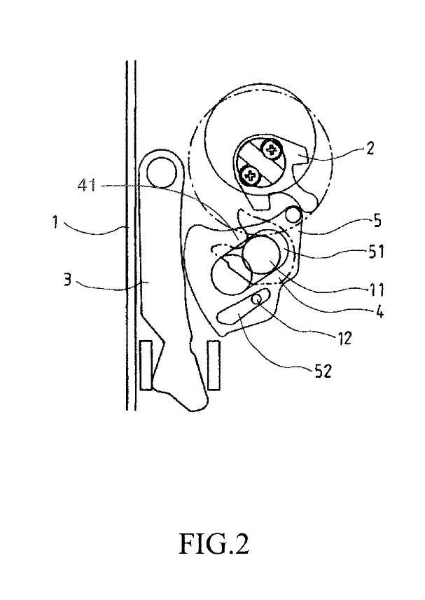

Referring to FIGS. 1 and 2, which are respectively a schematic view showing the structure of the present invention and a schematic view showing a free-to-open condition of the present invention, the present invention comprises a core shaft 2, a swing arm 3, a push bar 4, and a keeper plate 5 that are arranged in a lock 1 according to the present invention. The swing win 3 is arranged at one side of the core shaft 2 to selectively push or separate from a bolt 6. The push bar 4 is arranged on an axle 11 and has a top edge forming a notch 41. The keeper plate 5 comprises an elongate slide hole 51 formed therein and an elongate positioning hole 52 also formed therein and located below the slide hole 51. The slide hole 51 is slidably fit over the axle 11 and the positioning hole 52 is slidably fit over a bar 12 in such a way that the keeper plate 5 is movable up and down along a curved path. When the lock 1 is in a locked condition, the keeper plate 5 abuts against the core shaft 2 to prevent a handle from being operated from an outdoor side for opening. When a thief attempts to rotate the core shaft 2, due to being incapable of operating for opening, the thief may mistakenly believe the lock is damaged so that the thief may give up the attempt of intrusion. As such, the purpose of theft protection can be achieved. When an intruder has intruded and secures the lock 1 from the indoor side, a rescuer may use a key to open the core shaft 2 from the outdoor side.

Referring to FIG. 2, which is a schematic view showing a free-to-open condition of the present invention, reference also had to FIG. 1, according to the present invention, the keeper plate 5 is slidable downward to a lower position along the slide hole 51 so as to abut against the swing at arm 3 by being constrained by the positioning hole 52 that is located at the lower side, whereby the swing arm 3 is kept in position and is not allowed to abut and push the bolt 6. As such, the handle is in a condition of being free to rotate for opening.

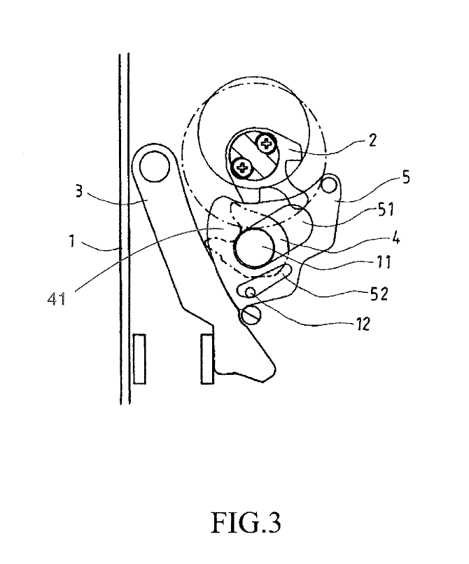

Referring to FIG. 3, which is a schematic view showing a locked condition of the present invention, reference also had to FIG. 1, according to the present invention, when the keeper plate 5, as being constrained by the positioning hole 52 at the lower side, is slidably moved upward along the slide hole 51 to an upper position, the swing arm 3 is no longer retained by the keeper plate 5 and is allowed to move laterally to push against the bolt 6 to achieve a locked condition, where the lock 1 can only be unlocked from the indoor side. When a thief attempts to rotate the core shaft 2, due to being impossible to open, the thief may mistakenly believe the lock is broken and thus gives up the attempt to break in. As such, the purpose of theft protection can be achieved.

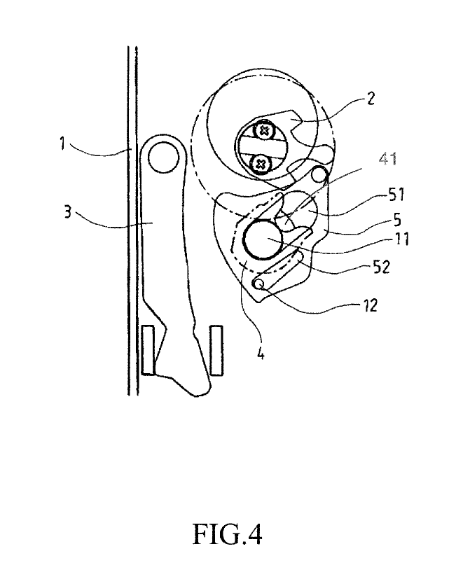

Referring to FIG. 4, which is a schematic view showing an unlocked condition of the present invention, reference also had to FIG. 1, when an intruder intrudes and secures the lock 1 from the indoor side, a rescuer may use a key to open the core shaft 2 from the outdoor side, causing the keeper plate 5 to slide down along the slide hole 51 and due to being constrained by the positioning hole 52 at the lower side to abut and retain the swing at arm 3. As such, the swing arm 3 is kept in position and is not allowed to push against the bolt 6 so that the lock 1 can be opened by rotating the handle.

In summary, the present invention provides an improved structure of lock by combining a core shaft, a swing arm, and a push bar with a slidable keeper plate to make thieves mistakenly believe the lock is damaged and thus giving up the attempt for breaking in so as to achieve the purpose of burglary protection and to allow rescuers to unlock the lock from an outdoor side by using a proper key even when an intruder secures the lock from the indoor side.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A lock structure, comprising a core shaft, a swing arm, and a keeper plate which are arranged in and partly constitute a lock, wherein the swing arm is arranged at one side of the core shaft and is movable between a first position, in which a bolt is kept in a first state, and a second position, in which the bolt is allowed to change from the first state to a second state, the keeper plate comprising an elongate slide hole formed therein and slidably fit over an axle in such a way that the keeper plate is movable between an up position and a down position along a curved path, wherein in the down position, the keeper plate abuts against and sets the swing arm in the second position to allow the bolt to change from the first state to the second state, and in the up position, the keeper plate allows the swing arm to move to the first position to keep the bolt in the second state.

2. The structure of lock according to claim 1, wherein the keeper plate comprises an elongate positioning hole formed therein and located below the slide hole, the positioning hole being slidably fit over a bar of the lock to effect positioning during sliding.
